(19) United States
(12) Patent Application Publication
(10) Pub. No.: US 2026/0196019 A1
(43) Pub. Date: Jul. 9, 2026

(54) MULTISCALE MIXED PIXEL DETECTION AND MASKING FOR ROBUST HIERARCHICAL CLUSTERING OF MULTI- AND HYPERSPECTRAL IMAGES

(71) Applicant: Saudi Arabian Oil Company, Dhahran (SA)

(72) Inventors: Sabbir Rahman, Dhahran (SA); Frankly Leonardo Toro Gonzalez, Thuwal (SA)

(21) Appl. No.: 19/009,246

(22) Filed: Jan. 3, 2025

(51) Int. Cl. G06V 10/762; G06V 10/30; G06V 10/44; G06V 20/10

(52) U.S. Cl. CPC G06V 10/7625; G06V 10/30; G06V 10/443; G06V 20/194

(57) ABSTRACT

Systems and methods include receiving a multispectral image corresponding to a region of interest. The multispectral image is processed, by applying a multidimensional edge detection filter to determine an edge index for the plurality of pixels and to determine edges within the multispectral image and by applying a multidimensional anomaly detection filter to determine an anomaly index to determine subpixel anomalies within the multispectral image. A variability index within the multispectral image is determined to generate a volatility map. A mixed pixel mask is applied to filter out impure pixels from the multispectral image to generate a map including pure pixels. A density seeking hierarchical clustering algorithm, such as single-link clustering, is applied to identify the clusters of pure materials in the multispectral image. A spectral unmixing procedure is applied to generate a map of materials in the multispectral image.

### TECHNICAL FIELD

The present disclosure is generally related to mixed pixel detection and, more specifically, to clustering algorithms for unsupervised segmentation of multispectral images.

### BACKGROUND

Even though multispectral images include information about the materials within the scanned area, the extraction and classification of the materials raises multiple technical challenges. For example, the complex and diverse appearances of materials that are exhibited due to lighting conditions, make traditional red green blue (RGB)-based approaches deceptive. The identification of materials based on spectral reflectance signatures is more reliable than traditional RGB but challenging because of difficulties in dataset segmentation. Material appearance classification is intricate, especially considering phenomena like metamerism, where identical RGB values can represent different materials. Most multispectral images include pixels that each represent multiple materials due to the limited spatial resolution of the imaging sensor. The mixed pixels introduce ambiguity and noise into the segmentation and classification process, leading to erroneous and unreliable results.

### SUMMARY

Implementations of the present disclosure are directed to mixed pixel detection. More particularly, implementations of the present disclosure are directed to clustering algorithms for unsupervised segmentation of multispectral images.

In some implementations, a method includes: receiving a multispectral image corresponding to a region of interest, the multispectral image including aerial images of the region of interest captured by a multispectral sensor, the multispectral image includes a plurality of pixels, processing the multispectral image, by applying a multidimensional edge detection filter to determine an edge index for the plurality of pixels and to determine edges within the multispectral image, processing the multispectral image, by applying a multidimensional anomaly detection filter to determine an anomaly index for the plurality of pixels and to determine subpixel anomalies within the multispectral image, determining, based on a local variability of spectra near each pixel within the multispectral image, a variability index within the multispectral image to generate a volatility map, applying a mixed pixel mask to filter out impure pixels from the multispectral image to generate a map including pure pixels, applying a density seeking hierarchical clustering algorithm, such as single-link clustering, to identify the clusters of pure materials in the multispectral image, applying a spectral unmixing procedure to generate a map of materials in the multispectral image, and identifying an action plan to remedy a risk associated with the map of materials.

The foregoing and other implementations can each optionally include one or more of the following features, alone or in combination. In particular, implementations can include all the following features. In some aspects, combinable with any of the previous aspects, the mixed pixel mask is determined by: applying a local normalization by dividing the edge index by the variability index, to generate a normalized edge index for the plurality of pixels in the multispectral image, applying a local normalization by dividing the anomaly index by the variability index, to generate a normalized anomaly index for the plurality of pixels in the multispectral image, and determining the mixed pixel mask by unifying a first portion of the pixels having highest normalized edge index and a second portion of the pixels having the highest normalized anomaly index, representing the impure pixels. The multidimensional edge detection filter includes a Scharr filter. The multidimensional anomaly detection filter includes a multidimensional 9-point Laplacian filter. Applying the mixed pixel mask to the multispectral image includes: locally normalizing the edges and the subpixel anomalies within the multispectral image using the volatility map, applying an edge filter mask to remove a portion of the edges and an anomaly filter mask to remove a portion of the subpixel anomalies to generate a map of pure pixels, applying a hierarchical clustering algorithm to the map of pure pixels to identify the clusters of pure materials, and applying a spectral unmixing procedure to generate a map of materials in the multispectral image. The computer-implemented method further includes comparing to the map of materials to a past map of materials to determine material change pattern. Identifying the action plan includes: determining a risk associated with the material change pattern, and generating an alert indicative of the risk associated with the material change pattern. Identifying the action plan includes activating an equipment to clean or protect one or more points of interests identified to be affected by the material change pattern.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features described herein, but also include any combination of the aspects and features provided.

Implementations described in the present disclosure, provide an accurate identification and masking of mixed pixels, facilitating the application of clustering algorithms to pure pixels that represent distinct and homogenous material features. The described approach efficiently removes the noise associated with mixed pixels, providing the advantage of significantly improving the separation of clusters in the feature space, resulting in more precise and stable cluster formation. The cluster formation improvement of the described implementations is particularly significant for density-seeking hierarchical clustering algorithms, such as single-link clustering, which are sensitive to noise, especially in the region between clusters. Another advantage of the described technology is that it ensures that only high-quality, non-mixed pixels are considered at all scales in the image, the segmentation process becoming more robust, producing clearer and more meaningful segmentations that better represent the range of materials in the image. The described technology substantially improves over existing methods in that it retains spectra representing pure materials that lie close to the boundaries of the pure clusters. The described technology provides a valuable tool for accurate multi/hyperspectral image analysis and interpretation with respective myriad applications. Another advantage of the described technology is that the described mapping of materials can trigger automatic operations for systems and machines configured to maintain environmental safety and system operability.

The details of one or more implementations of the subject matter of the specification are set forth in the accompanying drawings and the description below. Other features, aspects, and advantages of the subject matter can become apparent from the description, the drawings, and the claims.

### DESCRIPTION OF THE DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A is a block diagram of an example system that can be used to execute implementations of the present disclosure.

FIG. 1B is a block diagram of a portion of the example system that can be used to execute implementations of the present disclosure.

FIG. 2A illustrates an example of a multi- or hyperspectral image, according to some implementations of the present disclosure.

FIG. 2B illustrates an example 2-dimensional scatterplot of spectra from image in FIG. 2A, according to some implementations of the present disclosure.

FIG. 2C illustrates an example grayscale representation of application of the extended Scharr edge detection filter to the image in FIG. 2A, according to some implementations of the present disclosure.

FIG. 2D illustrates an example of grayscale representation of the variability of the spectra around each pixel, according to some implementations of the present disclosure.

FIG. 2E illustrates example result of locally normalizing the multidimensional Scharr filter by dividing the edge index by the local variability index, according to some implementations of the present disclosure.

FIG. 2F illustrates an example application of a standard 9-point Laplacian filter, according to some implementations of the present disclosure.

FIG. 2G illustrates an example application of a normalized 9-point Laplacian filter, according to some implementations of the present disclosure.

FIG. 2H illustrates an example combined mixed pixel mask with 50% of edges (shown in yellow) and 1% of subpixel anomalies (shown in in purple) removed, according to some implementations of the present disclosure.

FIG. 3 is a flowchart illustrating an example process for mixed pixel detection, in accordance with some example embodiments.

FIG. 4 depicts a block diagram illustrating a computing system, in accordance with some example embodiments.

When practical, like labels are used to refer to same or similar items in the drawings.

### DETAILED DESCRIPTION

The following detailed description describes techniques for mixed pixel detection. More particularly, implementations of the present disclosure are directed to clustering algorithms for unsupervised segmentation of multispectral images. The described implementations provide clustering algorithms for unsupervised segmentation of multispectral images. Multispectral images include mixed pixels that are filtered using multiple edge detection filters and pixels representing multiple materials are masked by a combination of mixed pixel masks. The map of pure material pixels reflect material distribution that facilitate automatic action initiation.

Some traditional multispectral image processing algorithms include edge detection to detect edges by applying one of a number of edge detection filters, which can measure the rate of change of the pixel intensity in both the horizontal and vertical directions. Traditional edge detection filters identify the strongest edges in an image. The identification of the strongest edges in an image typically represents only a small proportion of the total number of mixed pixels. The limitation to a small proportion of the total number of pixels leads to inaccurate results that require additional verification measures and minimize the chance of automatic introduction of remedial measures.

Addressing the limitations of traditional multispectral image processing, the techniques of the present disclosure effectively identify and mask out mixed pixels. An advantage of the described implementations is that they facilitate unsupervised segmentation of multispectral images leading to accurate material distribution mapping and automatic introduction of remedial measures. Masking out the mixed pixels as described in the present disclosure significantly improves the separation of clusters in the feature space and thereby facilitates clustering algorithms to accurately detect the natural material clusters present within a region of interest. The described approach provides an improvement of density-seeking hierarchical clustering algorithms, such as single-link clustering, which are sensitive to the noise generated by mixed pixels, especially in the region between clusters. By ensuring that only high-quality, non-mixed pixels are considered at all scales in the image, the segmentation process becomes more robust, producing clearer and more meaningful segmentations that more accurately represent the range of materials in the image.

The techniques described in the present disclosure provide a solution addressing the problems associated to environmental monitoring and compliance. The environmental monitoring and compliance can include spill detection and monitoring using real-time monitoring systems for rapid detection and tracking of oil spills and estimating spill volume and spread. Emissions monitoring can also include implementation of satellite-based monitoring systems to measure water quality parameters such as turbidity, chlorophyll concentration, and pollution levels and integrating with hydrological models to predict the impact of oil and gas operations on water bodies. Other applications of the described approach include exploration and discovery of material distribution for advanced seismic surveying techniques, surface geology mapping, and oil seeps detection.

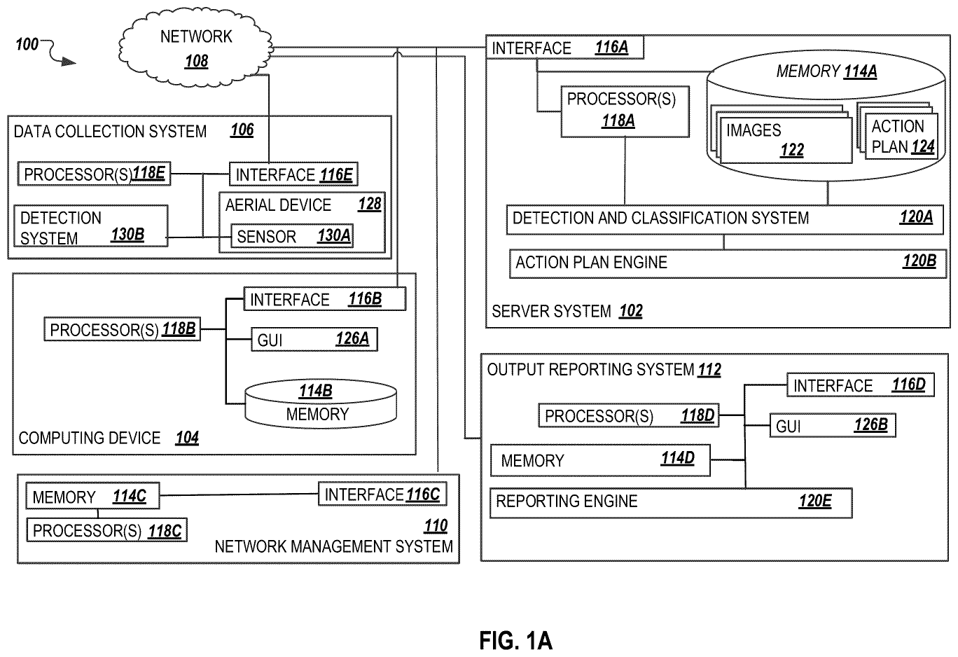

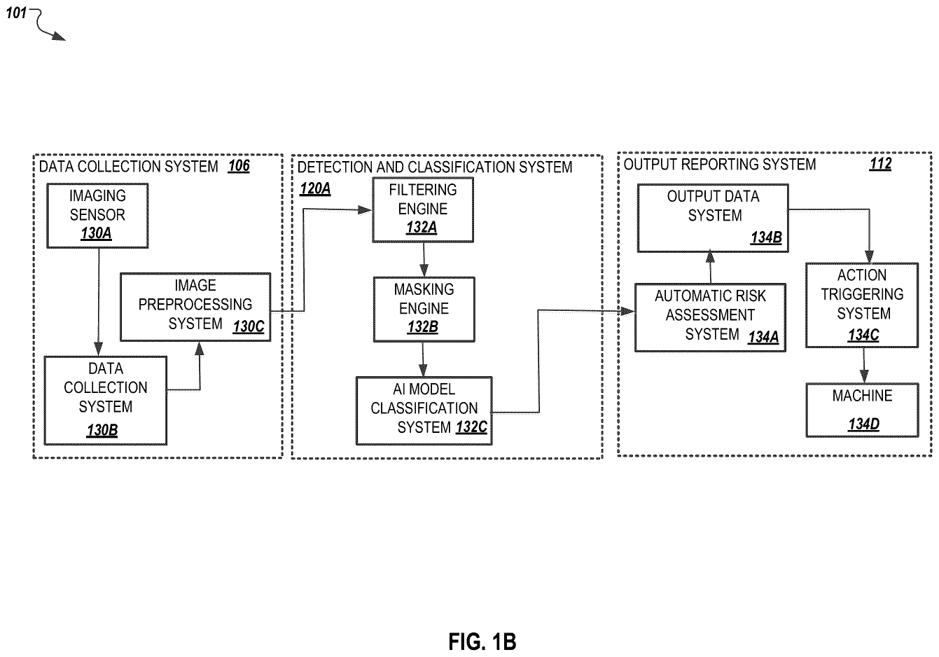

FIG. 1A is a block diagram illustrating an example system 100 that can be used to execute implementations of the present disclosure. For example, example system 100 can be configured to execute clustering algorithms for unsupervised segmentation of multispectral images. The illustrated example system 100 includes or is communicably coupled with a server system 102, a computing device 104, a data collection system 106, a network 108, a network management system 110, and an output reporting system 112. Although shown separately, in some implementations, functionality of two or more systems or components of the example system 100 may be provided by a single system or server. In some implementations, the functionality of one illustrated system, server, or component may be provided by multiple systems, servers, or components, respectively.

In the example of FIG. 1A, the server system 102 is intended to represent various forms of servers including, but not limited to a web server, an application server, a proxy server, a network server, and/or a server pool. In general, the server system 102 manages clustering algorithms for unsupervised segmentation of multispectral images. In accordance with implementations of the present disclosure, and as noted above, the server system 102 can host a solution environment that can be a cloud environment providing software applications, systems, and services that can be consumed by customers as a service. In some instances, the server system 102 can support configuring of various tenants of different types, as well as services of different types that are integrated in customer integration scenarios and support execution of defined processes.

For example, the server system 102 includes a memory 114A, an interface 116A, a processor 118A, and a detection and classification system 120 and an action plan engine 120B. The memory 114A can include multispectral images 122 and action plans 124. The multispectral images 122 include data measured by and received from the data collection system 106. The multispectral images 122 can include images detected by aerial sensors. The multispectral images 122 can be processed by the detection and classification system 120A to generate material maps that are processed by the action plan engine 120B to generate action plans 124. The action plans 124 in the memory 114A can include action plan documents defining remedial operations performed by systems and machine for management and redistribution of materials.

The computing device 104, the network management system 110, and the output reporting system 112 may each be any computing device operable to connect to or communicate in the network(s) 108 using a wireline or wireless connection. In general, each of the computing device 104, the network management system 110, and the output reporting system 112 includes an electronic computer device operable to receive, transmit, process, and store any appropriate data associated with the example system 100 of FIG. 1A. Each of the computing device 104, the network management system 110, and the output reporting system 112 is generally intended to encompass any client computing device such as a laptop/notebook computer, wireless data port, smart phone, personal data assistant (PDA), tablet computing device, one or more processors within these devices, or any other suitable processing device. The computing device 104, the network management system 110, and the output reporting system 112, respectively include interface(s) 116B, 116C, 116D, processor(s) 118B, 118C, 118D, and memories 114B, 114C, 114D.

The computing device 104 and the output reporting system 112, respectively include graphical user interface(s) (GUIs) 126A and 126B. For example, the GUIs 126A, 126B include an input device, such as a keypad, touch screen, or other device that can accept user information, and an output device that conveys information associated with the operation of the server system 102, or the client device itself, including a display of the material maps and action plan operations selected based on the material change patterns. The GUIs 126A, 126B each interface with at least a portion of the example system 100 for any suitable purpose, including generating a visual representation of the multispectral images collected by the data collection system 106, the material maps generated by the server system 102, or data stored by the server system 102, such as multispectral images 122 and action plans 124, respectively. In particular, the GUIs 126A, 126B may each be used to view and adjust various action plans. Generally, the GUIs 126A, 126B each provide the user with an efficient and user-friendly presentation of the material maps and action plans including material change patterns communicated within the example system 100. The GUIs 126A, 126B may each include multiple customizable frames or views having interactive fields, for selection of regions of interest and/or display of material maps for different regions and time points. The GUIs 126A, 126B can each be any suitable graphical user interface, such as a combination of a generic web browser, intelligent engine, and command line interface (CLI) that processes information and efficiently presents the results to the user visually.

The output reporting system 112 can include a reporting engine 120C, the GUI 126B (dashboard), an interface 116D, and a processor 118D. The reporting engine 120C utilizes the analytics data provided by the action plan engine 120B to produce executive and semi executive level displays for the GUI 126B. The GUI 126B displays a high-level summary of a material map assessment, which provides support for material change patterns in addition to key recommended actions for environment and plant safety. The GUI 126B display can facilitate material management and decision makers to modify (operations of) the systems and machines selected for cleaning identified materials.

The data collection system 106 can include multiple imaging sensors 130A and a detection system 130B. The imaging sensors 130A can be within an aerial device 128 (e.g., attached to or included in the aerial device), acquiring samples and data during a flight or hovering operation. The imaging sensors 130A and the detection system 130B can include any of a hyperspectral sensor, spectroradiometers (e.g., ultraviolet/visible/near infrared/short wave infrared spectroradiometers), a camera, and other types of probes. The processor 118E of the data collection system 106 controls operation of the imaging sensors 130A and the detection system 130B and directs collected and determined data to the server system 102 for storage, further analysis, and modelling. The imaging sensors 130A and the detection system 130B can collect multispectral images of one or more areas of interest below the aerial device 128. Further details about the imaging sensors 130A and the detection system 130B and their operation are provided with reference to FIG. 1B.

In some implementations, the network 108 can include a large computer network, such as a local area network, a wide area network, the Internet, a cellular network, a telephone network, or any appropriate combination thereof connecting any number of communication devices, mobile computing devices, fixed computing devices and server systems. Data exchanged over the network 108, is transferred using any number of network layer protocols, such as Internet Protocol, Multiprotocol Label Switching, Asynchronous Transfer Mode, Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 118A, 118B, 118C, 118D, 118E included in different components of the example system 100 can include a central processing unit, an application particular integrated circuit, a field-programmable gate array, or another suitable component. Generally, each processor 118A, 118B, 118C, 118D, 118E executes instructions and manipulates data for mixed pixel detection. Each processor 118A, 118B, 118C, 118D, 118E executes a functionality required to monitor multispectral images associated to an aerial device 128, to monitor and correct material change patterns.

Interfaces 116A, 116B, 116C, 116D, 116E are used by different components of the example system 100 for communicating with other component systems in a distributed environment—including within the example system 100—connected to the network 108. Generally, the interfaces 116A, 116B, 116C, 116D, 116E each include logic encoded in software and/or hardware in a suitable combination and operable to communicate with the network 108. More specifically, the interfaces 116A, 116B, 116C, 116D, 116E may each include software supporting one or more communication protocols associated with communications such that the network 108 or interface's hardware is operable to communicate physical signals within and outside of the illustrated system 100.

The memory 1114A, 114B, 114C, 114D may include any type of memory or database module and may take the form of volatile and/or non-volatile memory including, without limitation, magnetic media, optical media, random access memory, read-only memory, removable media, or any other suitable local or remote memory component. The memory 1114A, 114B, 114C, 114D may store various objects or data, including caches, classes, frameworks, applications, backup data, business objects, jobs, web pages, web page templates, database tables, database queries, repositories storing images 122 (e.g., multispectral images and/or dynamic information, and any other appropriate information including material change pattern models, and any material cleaning parameters, variables, algorithms, instructions, rules, constraints, or references thereto) associated with the purposes of the server system 102, the computing device 104, the data collection system 106, the network management system 110, and the output reporting system 112, respectively.

There may be any number of computing devices 104 and data collection systems 106 associated with, or external to, the example system 100. Additionally, there may also be one or more additional client devices external to the illustrated portion of system 100 that are configured for interacting with the example system 100 via the network(s) 108. Further, the term “client,” “client device,” and “user” may be used interchangeably as appropriate without departing from the scope of the disclosure. Moreover, while client device may be described in terms of being used by a single user, the disclosure contemplates that many users may use one computer, or that one user may use multiple computers. As used in the present disclosure, the term “computer” is intended to encompass any suitable processing device. For example, although FIG. 1A illustrates a single server system 102, a single computing device 104, a single data collection system 106, a single network management system 110, the example system 100 can be implemented using a single, stand-alone computing device, two or more core systems 102, or multiple client devices. The server system 102, the computing device 104 and the output reporting system 112 may include any computer or processing device such as, for example, a blade server, general-purpose personal computer, workstation, or any other suitable device. In other words, the present disclosure contemplates computers other than general purpose computers, as well as computers without conventional operating systems. Further, the server system 102 and the computing device 104 and the output reporting system 112 may be adapted to execute any operating system or runtime environment. According to one implementation, the server system 102 may also include or be communicably coupled with an e-mail server, a Web server, a caching server, a streaming data server, and/or another suitable server, as described with reference to FIG. 1B.

FIG. 1B is a block diagram of a portion of the example system 100 that can be used to execute implementations of the present disclosure. In particular, FIG. 1B depicts a schematic diagram illustrating an example portion 101 of a variation of the example system 100 described with reference to FIG. 1A, in accordance with some example embodiments. The example portion 101 of the example system 100 illustrated in FIG. 1B includes the data collection system 106, a detection and classification system 120A, and an output reporting system 112.

The data collection system 106 includes imaging sensors 130A, a data collection system 130B, and an image preprocessing system 130C. The imaging sensors 130A can be coupled to the aerial device 128 and can be displaced to capture multispectral images of multiple regions of interest. The imaging sensors 130A and the detection system 130B are communicatively connected to the processor 118E. The imaging sensors 130A can include RGB imaging devices, multispectral sensors, and hyperspectral sensors (e.g., infrared imaging spectrometers), or other imaging systems facilitating the collection of multispectral images. The data collection system 130B can generate triggers according to a particular schedule to control data collection executed by the imaging sensors 130A. The data collection system 130B can receive the multispectral images collected by the imaging sensors 130A and transmit them to the image preprocessing system 130C for pre-processing.

The image preprocessing system 130C executes pre-processing of multispectral images that can enhance data quality and can ensure accurate downstream analysis. Pre-processing can include: noise correction to remove sensor noise using correction coefficients during image processing; vignetting correction to address uneven illumination across the image caused by lens vignetting; lens distortion correction to apply distortion models (such as the brown model) to correct lens-induced distortions; band registration to align spectral bands to ensure consistent spatial information; and radiometric correction to normalize pixel values to account for variations in sensor sensitivity. For UAV-based multispectral sensors, these steps optimize data quality, enabling accurate material monitoring and other applications.

The detection and classification system 120A includes a filtering engine 132A, a masking engine 132B, and an artificial intelligence (AI) model classification system 132C. The filtering engine 132A applies any of a multidimensional edge detection filter, a multidimensional 9-point Laplacian filter and can generate a volatility map and a locally normalized edge index. The masking engine 132B can create an edge filter mask, an anomality filter mask, a mixed pixel mask and can generate a map of materials. The AI model classification system 132C can process multiple maps of materials of a particular region, corresponding to multiple time points to generate material variation patterns. The AI model classification system 132C can include machine learning techniques (e.g., neural networks) trained to analyze spatial data and reveal patterns over time.

The output reporting system 112 includes an automatic risk assessment system 134A, an output data system 134B, an action triggering system 134C, and a machine 134D. The automatic risk assessment system 134A can process the material variation patterns and most recently generated maps of materials to determine risks associated to one or more points of interests (e.g., roads, industrial plants, oil drilling and processing systems, etc.). The output data system 134B can include a GUI (e.g., GUI 126 described with reference to FIG. 1A) to generate displays indicating the identified risk. The action triggering system 134C can receive the determined risk, classify the risk (e.g., low, medium, or high) and, based on the classification, generate a trigger to send to the machine 134D to perform a remedial action (e.g., cleaning or relocation of material within the region of interest to protect the one or more points of reference).

While portions of the example system 100 illustrated in FIGS. 1A and 1B are shown as individual modules that implement the various features and functionality through various objects, methods, or other processes, the hardware components can execute software that can include multiple sub-modules, third-party services, components, libraries, and such, as appropriate. Conversely, the features and functionality of various components can be combined into single components as appropriate.

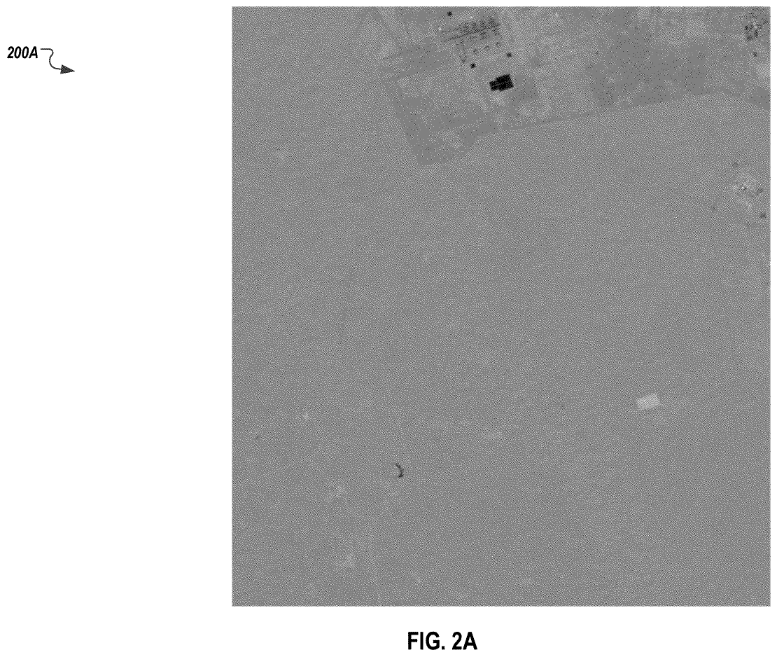

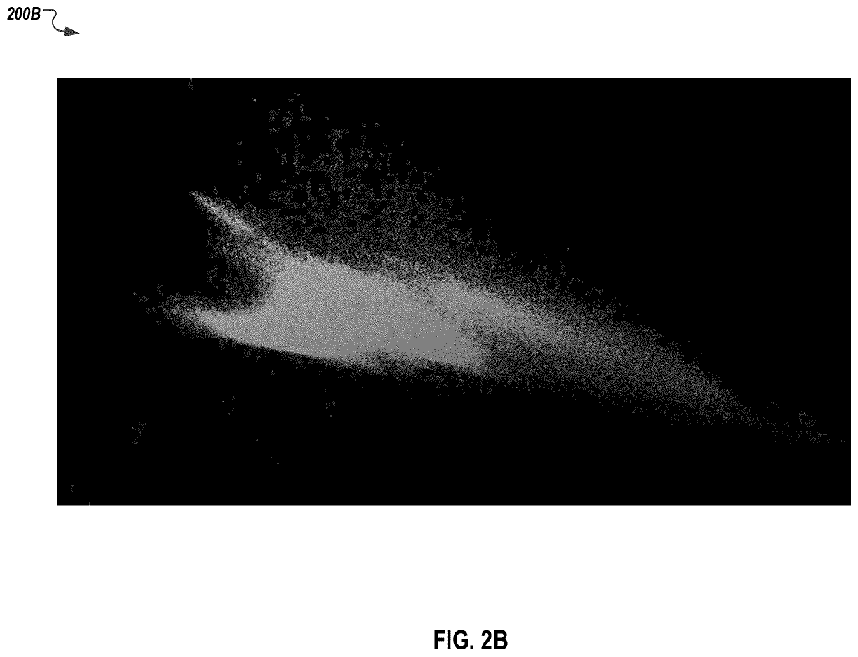

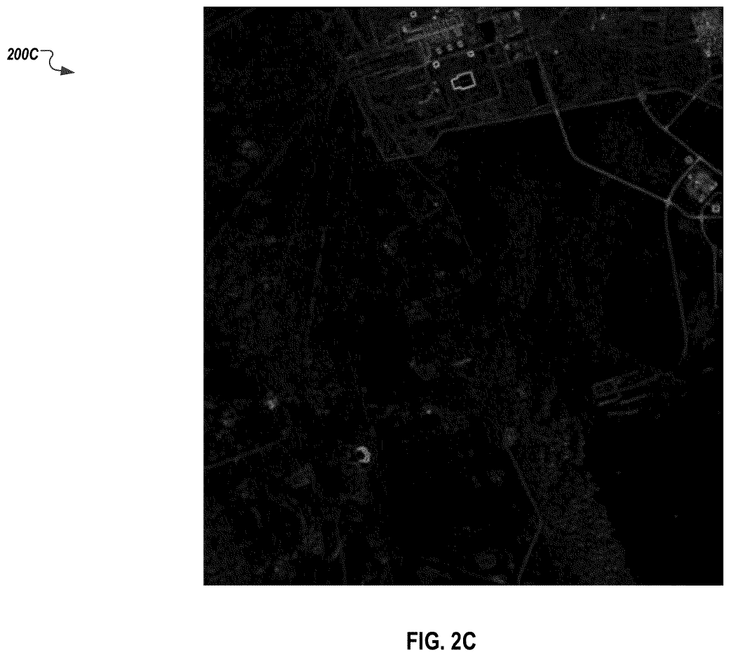

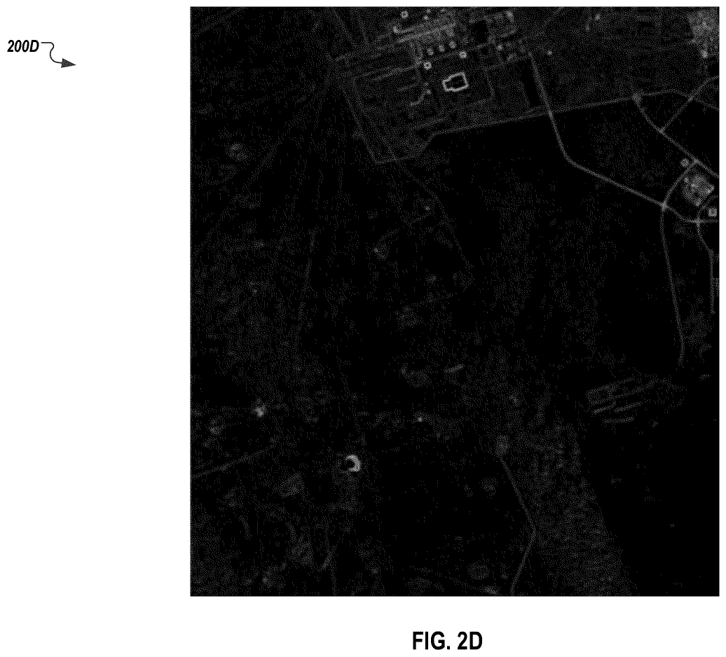

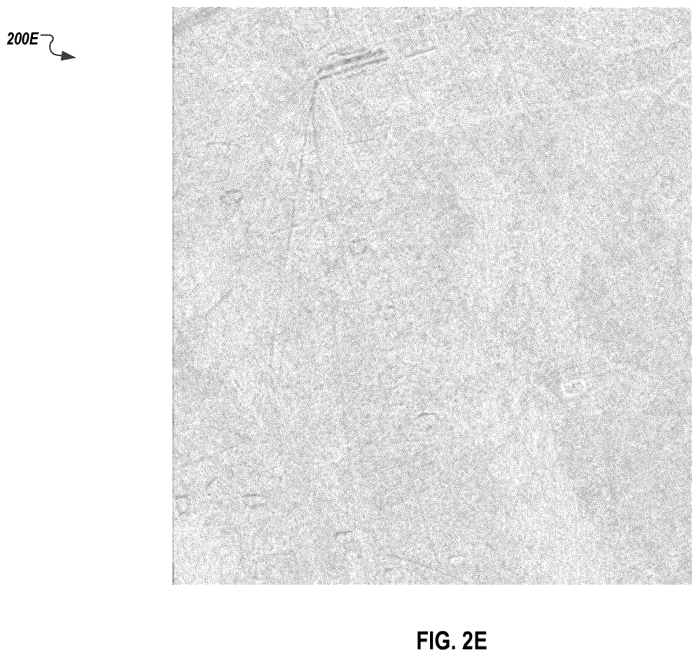

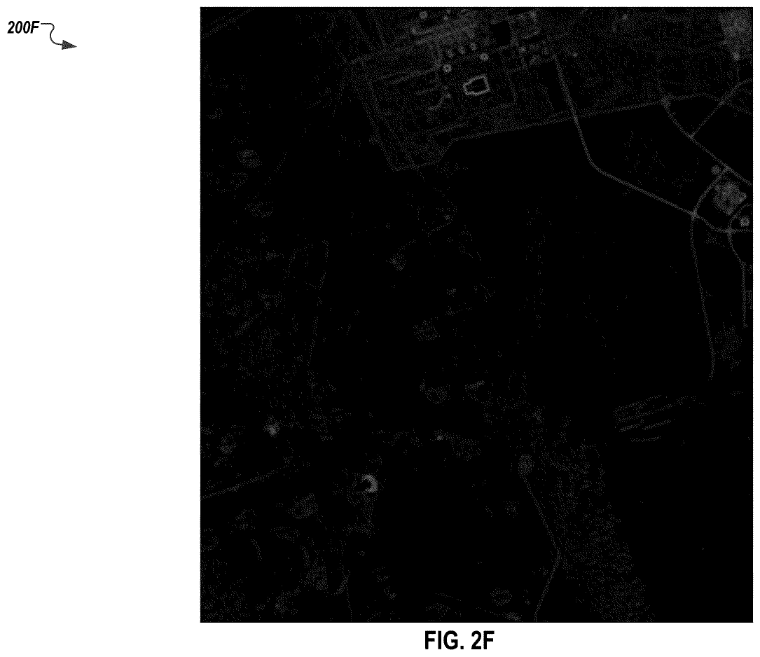

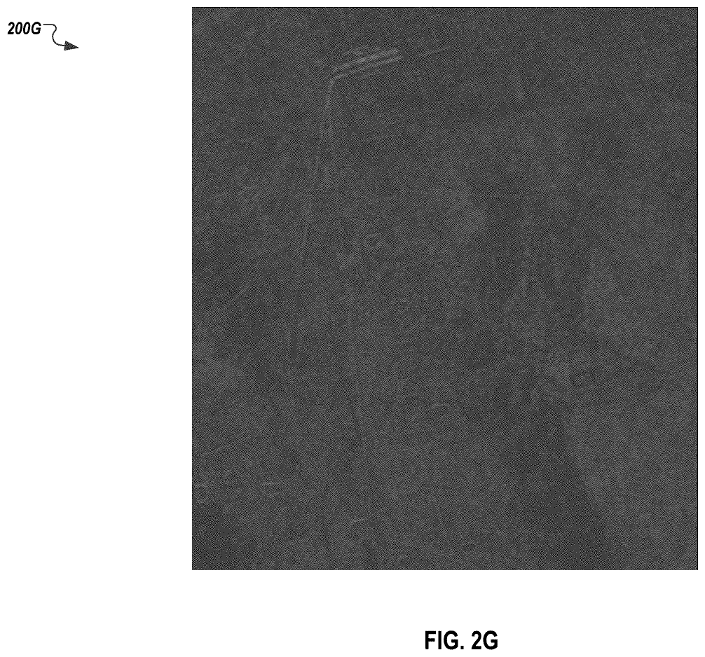

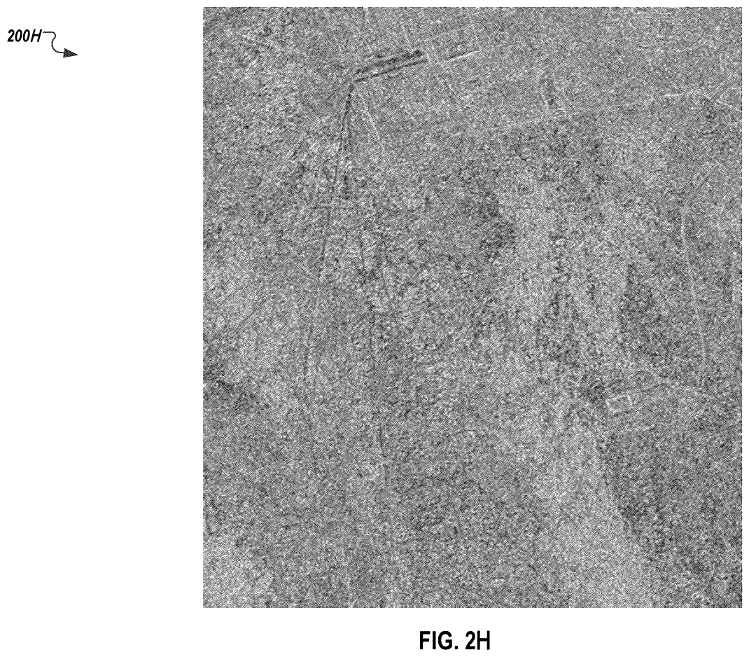

FIG. 2A illustrates an example of a multi- or hyperspectral image 200A, according to some implementations of the present disclosure. The example of a multi- or hyperspectral image 200A can have N=W*H pixels (with width W and height H), with each pixel having an associated spectrum consisting of C “channels” (or “bands”, or “dimensions”). For example, the example of a multi- or hyperspectral image 200A has 1,262×1,533=1,934,646 pixels with 12 bands. The example of a multi- or hyperspectral image 200A can be captured by multispectral sensors that generate data in a few wavelength bands (e.g., 3 to 10 bands), such as red, green, blue, near infrared, and short-wave infrared. The bands can have descriptive titles and a spatial resolution of 30 meters (except for a few particular bands). The example of a multi- or hyperspectral image 200A can help identify land cover, vegetation health, oil spills, sand encroachment, and water quality. The example of a multi- or hyperspectral image 200A can include hyperspectral imagery to provide detailed spectral information, facilitating identification of particular materials and respective unique signatures.

FIG. 2B illustrates example 2-dimensional scatterplot 200B of the first two principal components of spectra from image in FIG. 2A, according to some implementations of the present disclosure. The example 2-dimensional scatterplot 200B can include a set of spectra associated with the pixels that can be represented as vectors in a 12-dimensional space, where materials with similar spectra can form clusters of high density. Every point in the example 2-dimensional scatterplot 200B can correspond to the spectrum of a vector associated with a pixel in the example of a multi- or hyperspectral image 200A, described with reference to FIG. 2A.

FIG. 2C illustrates an example grayscale representation 200C of application of the extended Scharr edge detection filter to the image in FIG. 2A, according to some implementations of the present disclosure. The example grayscale representation 200C can be generated by an extended Scharr edge detection filter that is a variant of the Scharr filter, which is commonly used for edge detection in images. When applied to a multi- or hyperspectral image 200A or the 12-dimensional scatterplot 200B, it highlights areas of rapid intensity change, indicating edges or boundaries between different materials or objects. The example grayscale representation 200C includes a grayscale representation after applying the extended Scharr filter to a hyperspectral image: enhanced edges, noise suppression, and fine details. The enhanced edges are visible because the filter emphasizes edges by detecting abrupt changes in intensity (gradient) along both horizontal and vertical directions. Strong edges of the example grayscale representation 200C appear as bright lines. The noise suppression of the example grayscale representation 200C is facilitated by the Scharr filter being less sensitive to rotation of edges compared to other edge detection filters like the Sobel or Prewitt filters. The noise in the hyperspectral image may be reduced, resulting in more accurate edge maps. The fine details of the example grayscale representation 200C are visible because the extended Scharr filter provides better sensitivity to fine details, making it suitable for detection of edges at multiple scales within the same image. It can reveal subtle features such as thin lines, boundaries, and texture variations. The particular appearance of edges and features of the example grayscale representation 200C can depend on the content of the hyperspectral image and the chosen filter parameters.

FIG. 2D illustrates an example of grayscale representation 200D of the variability of the spectra around each pixel, according to some implementations of the present disclosure. The example of grayscale representation 200D represents intensity information of the spectra around each pixel using shades of gray. Each pixel of the example of grayscale representation 200D corresponds to a single sample of light intensity, ranging from 0 (black) to 255 (white) 1. The variability of spectra around each pixel of the example of grayscale representation 200D, shows how the spectral values change across neighboring pixels. The grayscale representation of spectral variability of the example of grayscale representation 200D illustrates local variations, material boundaries, and texture and patterns. Local variations of the example of grayscale representation 200D can include darker areas indicate regions with low spectral variability, where neighboring pixels have similar spectral values. Brighter areas of the example of grayscale representation 200D correspond to regions with high variability, where neighboring pixels exhibit significant differences in their spectral signatures. Material boundaries of the example of grayscale representation 200D can be defined by spectral variability often highlights material boundaries or transitions. For example, if the example of grayscale representation 200D contains vegetation and soil, the boundary between them may appear as a distinct edge in the grayscale representation. Texture and patterns of the example of grayscale representation 200D can include fine-scale texture and patterns within an image become visible. The variations of the example of grayscale representation 200D can reveal details like surface roughness, vegetation health, or geological features. The particular appearance of spectral variability of the example of grayscale representation 200D depends on the type of hyperspectral data and the context of the multi- or hyperspectral image 200A, described with reference to FIG. 2A.

FIG. 2E illustrates example normalized image 200E of locally normalizing the multidimensional Scharr filter by dividing the edge index by the local variability index, according to some implementations of the present disclosure. The example normalized image 200E illustrates a local variability index that characterizes how much the spectral values vary within a local neighborhood around each pixel. The example normalized image 200E provides information about the texture, material transitions, and fine-scale details. Normalization by dividing the edge index (computed by the Scharr filter) by the local variability index, can normalize the edge response within the example result 200E. This normalization accounts for variations in the spectral content of the example normalized image 200E and makes the edge detection more robust across different regions and at multiple scales of the example normalized image 200E.

FIG. 2F illustrates an example filtered image 200F generated by a standard 9-point Laplacian filter, according to some implementations of the present disclosure. Applying a standard 9-point Laplacian filter to the example normalized image 200E serves as an anomaly detection technique generating the example filtered image 200F. The Laplacian filter highlights regions of highly localized intensity change, making it useful for anomaly detection. The Laplacian response can be divided by the local variability index. The example filtered image 200F can emphasize subpixel anomalies in the example original image 200A. Bright regions of the example filtered image 200F can indicate significant localized intensity changes, corresponding to such localized anomalies.

FIG. 2G illustrates another example filtered application 200G of a normalized 9-point Laplacian filter, according to some implementations of the present disclosure. The example filtered application 200G can be generated by applying a normalized 9-point Laplacian filter using a normalized image 200E to enhance anomaly detection while accounting for variations in spectral content. The example filtered application 200G can emphasize localized anomalies at multiple scales in the original image 200A including bright regions that indicate subpixel anomalies, corresponding to subpixel anomalies that are different from those identified by a standard 9-point Laplacian filter, as described with reference to FIG. 2F.

FIG. 2H illustrates an example combined mixed pixel mask image 200H with a particular edge percentage (e.g., 50%) of edges (shown in yellow) and a particular percentage (e.g., 1%) of subpixel anomalies (shown in in purple) removed, according to some implementations of the present disclosure. The example combined mixed pixel mask image 200H illustrates results of combined mixed pixel mask used to remove mixed pixels which occur both as edges at the border of two materials or as subpixel anomalies where a subpixel object distorts the spectrum of the surrounding material in a given pixel.

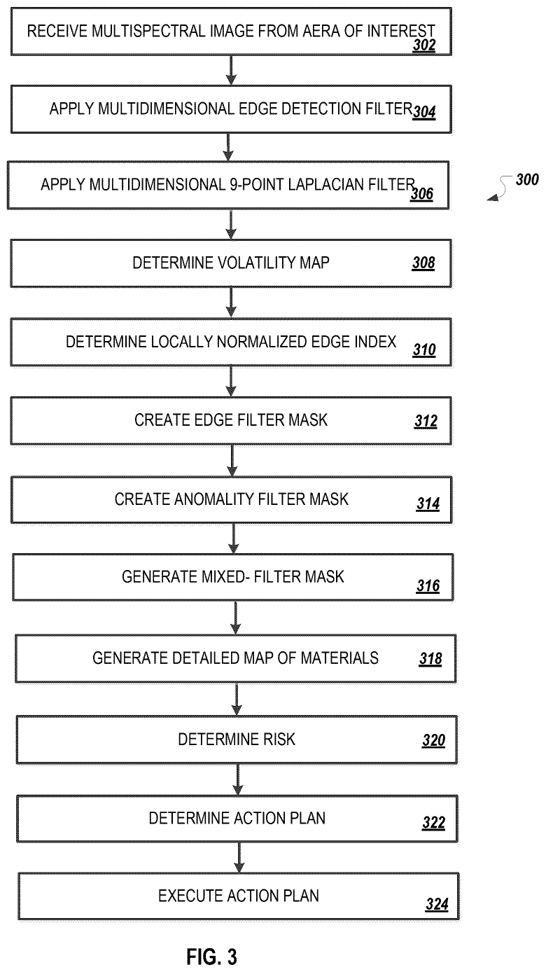

FIG. 3 depicts a flowchart illustrating an example process for clustering algorithms for unsupervised segmentation of multispectral images, in accordance with some example embodiments. Referring to FIGS. 1A and 1B, the process 300 can be performed by any components of the example system 100.

At 302, a multispectral image is received, by one or more processors, from a region of interest. The multispectral image can be received from a satellite, or an aerial device (e.g., aerial device 128 described with reference to FIG. 1A) equipped with a multispectral image acquisition device. A typical multi- or hyperspectral image (e.g., example multispectral image 200A) can have N=W*H pixels (with width W and height H), with each pixel having an associated spectrum consisting of C “channels” (or “bands”, or “dimensions”). The set of spectra associated with the pixels can be represented as vectors in a multi-dimensional (e.g., 12-dimensional) space, where materials with similar spectra can form clusters of high density. The multispectral image can be processed to obtain one or two-dimensional cross sections showing the first two principal components of the 12-dimensional spectral vector space. Every point in the scatterplot can correspond to the spectrum of a vector associated with a pixel in the original multispectral image. The set of spectra associated with the pixels can be represented as a scatterplot including vectors in a 12-dimensional space, where materials with similar spectra can form clusters of high density. Every point in the scatterplot corresponds to the spectrum of a vector associated with a pixel in the original image.

At 304, a multidimensional edge detection filter is applied, by the one or more processors. In order to mask out the “impure” pixels, an edge detection filter is first applied. Applying the edge detection filter can include a convolution with a 3×3 edge detection filter for detecting edges in grayscale images. The application of the edge detection filter can effectively measure the gradients Gₓ and G_{y} in the x- and y-directions respectively at each pixel, with the overall gradient measure for the pixel given by:

$$G = \sqrt{{G}_{x}^{2} + {G}_{y}^{2}}$$

The edge detection filter can be applied to a grayscale conversion of the multispectral image. The edge detection filter can include a Sobel filter or a Scharr filter. The 3×3 Scharr filter has a better rotational invariance than the Sobel filter. The Scharr filter can be the basis of the normalized multidimensional edge detection filter: The form of the Scharr filter for measurement of gradients in the x-direction is:

$${h}_{x}^{′} ( : , : ) = \begin{matrix}- 47 & & 0 & 47 \\ [ - 167 & & 0162 ] & \\ - 47 & 0 & 47 & \end{matrix} \text{}$$

The negative transpose of the filter is the Scharr filter in the y-direction. In order to apply Scharr filter to multi- and hyperspectral images, the x- and y-direction filters are both extended into a cuboid of length equal to the number D of bands in the image (e.g., 12 bands). Each 3×3 layer of the 3×3×D filters that result can contain the same values as above. In order for the resulting filter to be applied to the edge and corner pixels, linear interpolation can be used to extend the image by one pixel at the edges and corners for the top left corner of one band of the image. The linear interpolation can be done for all of the edge and corner pixels in all of the bands. Add a border around each band of the image by linearly interpolating the values by one pixel. The x- and y-direction Scharr filters can be applied band-by-band and pixel-by-pixel to the entire image to obtain G_{x[k]} and G_{y[k]} for each pixel where k denotes the band. For example, the formula for calculating G_{x[k]} by applying Gₓ to pixel (i,j) in band k of the image (where “I” is the x-coordinate “j” is the y-coordinate) is given by:

$${G}_{x [ k ]} = 47. * ( v [ i ] [ j ] [ k ] + v [ i ] [ j + 2 ] [ k ] - v [ i + 2 ] [ j ] [ k ] - v [ i + 2 ] [ j + 2 ] [ k ] ) + 162. * ( v [ i ] [ j + 1 ] [ k ] - v [ i + 2 ] [ j + 1 ] [ k ] ) ,$$

The term v[i][j][k] is the value of the pixel (i,j) in band k. The strength of the edge for a given pixels is then the square root of the sum over all bands of G_{x[k]}*G_{x[k]}+G_{y[k]}*G_{y[k]}. This can also be represented as a matrix convolution. The term G_{y[k]} is calculated for the pixel in band k in the same way, and the set of G_{x[k]} and G_{y[k]} over all bands is used to calculate the edge index G for the pixel (e.g., FIG. 2C shows the result of calculating the edge index for all pixels in the image).

At 306, a multidimensional anomaly filter is applied, by the one or more processors to the multispectral image. The multidimensional anomaly filter includes a multidimensional 9-point Laplacian filter. The 9-point Laplacian filter can be designed as a 3×3 matrix, such as:

$$[ \text{} \begin{matrix}0.25 & 0.5 & 0.25 \\ 0.5 & - 3. & 0.5 \\ 0.25 & 0.5 & 0.25\end{matrix} \text{} ]$$

The 9-point Laplacian filter can be extended into a cuboid of length equal to the number of bands and can be applied as local normalization to the result.

At 308, a volatility map is determined, by the one or more processors. Different material classes can naturally have different levels of variability between samples, e.g. sandy pixels can tend to be more similar to neighboring sand pixels than can tree or vegetation pixels. In order to avoid all of the edges appearing to be in the trees at the expense of more important but weaker edges in the sand (e.g., when detecting sand encroachment), the edge detection filters applied to each pixel can be normalized by the local variability of the spectra associated with the pixel's immediate neighborhood. The edges at all levels of granularity are identified by calculating the local variability of the spectra proximal to each pixel and by calculating the standard deviation of the Euclidean distances of the set of nine D-dimensional spectra of the pixels in its 3×3 neighborhood from the respective additive mean. The variability index is calculated for each pixel in the image and is also shown for our sample image.

At 310, a locally normalized edge index is determined, by the one or more processors. In order to obtain a locally normalized edge index, the edge detection results, and Laplacian filter results are divided by the volatility map. The division is performed for each pixel for which the variability index of the volatility map is used for division. The division result can be a multiscale edge index map, wherein the edges are detected uniformly throughout the image. The uniform edge detection throughout the image facilitates extraction of the entire hierarchy of materials, and not just a few discrete materials. An analogous process to the above for detection of edges is now applied to mask out subpixel anomalies. The most commonly used filter for anomaly detection is the Laplacian filter. In some implementation, a 9-point version of the Laplacian filter can include better rotational properties for anomaly detection, similar to the Scharr filter.

At 312, an edge filter mask is created, by the one or more processors. The edge filter mask can be created from the results of normalized edge detection filter that are sorted and a first portion (e.g., about top 50%) of the pixels can be masked out prior to clustering.

At 314, an anomality filter mask is created, by the one or more processors. In the same way, once the normalized anomaly detection filter has been calculated, the results are sorted and a selected second portion (e.g., about top 1%) of pixels containing subpixel anomalies are removed prior to clustering.

At 316, a mixed pixel mask is generated, by the one or more processors. The mixed-pixel mask can be applied to a multispectral or hyperspectral image. The “impure” mixed pixels to be masked from the original image consists of the union of the pixels in the edge mask and the pixels in the anomaly mask. The final set of masked pixels can include about or more than 50% of the pixels in the image. Once the masked pixels have been removed, the result includes a map of “pure” materials.

At 318, a detailed map of the abundance of each material in the image is generated, by the one or more processors. The map of “pure” materials can be processed using a hierarchical clustering algorithm (such as single-link) to generate the hierarchy of pure material clusters (or “endmembers”) present in the image, which can be used to unmix the pixels that have been masked in order to generate a detailed map of the abundance of each material in the image. The spectral unmixing can be applied to calculate the precise materials composition of the impure pixels, or any other spectra from images containing similar materials to the original image. The material composition can be used to identify anomalous or subpixel materials, or to constrain the respective spectra which can then be compared with a reference library of materials/endmembers. In particular, the material composition can be used to detect and estimate the abundance of trace materials such as greenhouse gas emissions or pollutants whose spectra are known. The hierarchical cluster analysis can then be applied to the image to generate a complete hierarchy of material clusters. A cluster selection algorithm can optionally be applied to generate a library of key reference clusters or endmembers. statistical models can be built of the clusters of interest. The statistical models can be used directly for materials classification or anomaly detection for example.

At 320, a risk is determined, by the one or more processors. The risk can be determined by performing a temporal variation of materials over the region of interest. For example, changes in the material abundance in temporally separated images of the same region can be used for change detection, monitoring and object/materials tracking and material variation patterns. The temporal variation analysis can be applied to scan large regions either domestically or globally for large scale mapping, safety, and security.

At 322, an action plan defining an action and a corresponding surface equipment is determined, by the one or more processors. The action plan can be identified by machine learning models (e.g., recurrent neural networks with a multi-layer network topology) trained and fine-tuned to generate an automatic selection of an efficient remedial action (e.g., activation of one or more cleaning machines or deactivation of one or more systems for safety and protection of an environment and an industrial plant). The surface equipment can be selected to match the characteristics of the material change pattern and execute the intended material cleaning or removal operations. The trained machine learning models can be configured to operate in active mode, for material change pattern identification, facilitating automatic action plan implementation. For example, the trained machine learning models can trigger an initiation of the action plan, and a modification of surface equipment operations based on most recent map of materials relative to the predicted material change pattern.

At 324, the action plan is automatically executed by generating a trigger, by the one or more processors, to activate an operation of a system or a machine configured to perform a remedy operation (e.g., cleaning, filtering, or material removal operation).

The example process 300 facilitates optimization of accurate generation of material map. One of the greatest benefits of generation of an accurate material map is that it facilitates activation of automatic remedial machine actions to ensure continuous workflows and access to facilities. The example process 300 enhances a characterization of regions of interest, providing resource conservation opportunities by minimizing computing system requirements and optimization of monitorization of a large range of materials.

In some implementations, customized user interfaces can present intermediate or final results of the above-described processes on a user interface of a user device. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, material management associated with overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period-of-time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. The described technology can be especially useful for systems or various pieces of equipment that are located several meters or several miles apart or are located in different countries or other jurisdictions.

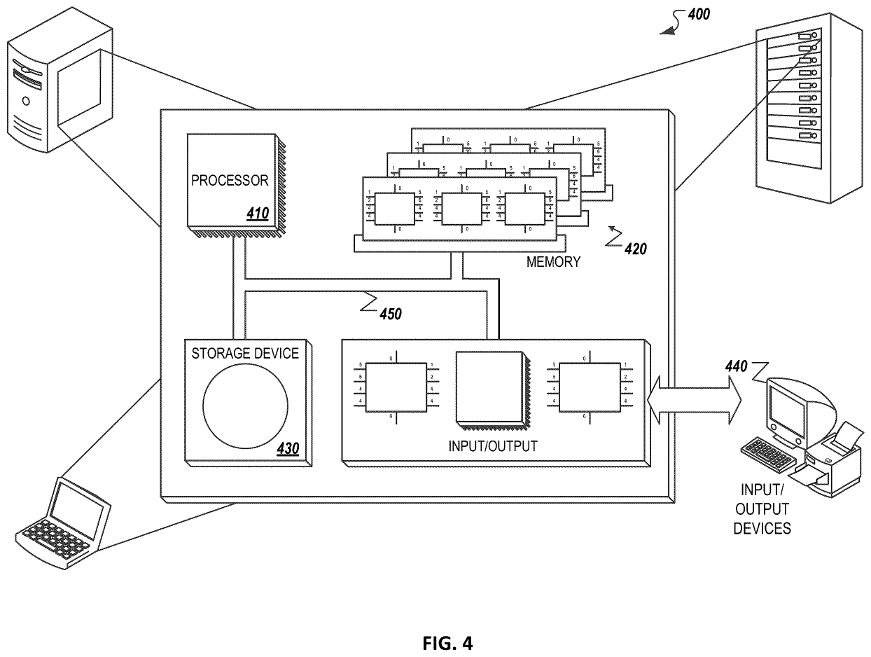

FIG. 4 depicts a block diagram illustrating a computing system 400, in accordance with some example embodiments. Referring to FIGS. 1A and 1B, the computing system 400 can be used to implement the server system 102 and/or any other components of the example system 100.

As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the example system 100. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities or can be standalone computing products and/or functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications may be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising: receiving a multispectral image corresponding to a region of interest, the multispectral image comprising aerial images of the region of interest captured by a multispectral sensor, the multispectral image comprises a plurality of pixels; processing the multispectral image, by applying a multidimensional edge detection filter to determine an edge index for the plurality of pixels and to determine edges within the multispectral image; processing the multispectral image, by applying a multidimensional anomaly detection filter to determine an anomaly index for the plurality of pixels and to determine subpixel anomalies within the multispectral image; determining, based on a local variability of spectra near each pixel within the multispectral image, a variability index within the multispectral image to generate a volatility map; applying a mixed pixel mask to filter out impure pixels from the multispectral image to generate a map comprising pure pixels; applying a density seeking hierarchical clustering algorithm, such as single-link clustering, to identify the clusters of pure materials in the multispectral image; applying a spectral unmixing procedure to generate a map of materials in the multispectral image; and identifying an action plan to remedy a risk associated with the map of materials.

Example 2. The computer-implemented method of the preceding example, wherein the mixed pixel mask is determined by: applying a local normalization by dividing the edge index by the variability index, to generate a normalized edge index for the plurality of pixels in the multispectral image; applying a local normalization by dividing the anomaly index by the variability index, to generate a normalized anomaly index for the plurality of pixels in the multispectral image; and determining the mixed pixel mask by unifying a first portion of the pixels having highest normalized edge index and a second portion of the pixels having the highest normalized anomaly index, representing the impure pixels.

Example 3. The computer-implemented method of any of the preceding examples, wherein the multidimensional edge detection filter comprises a Scharr filter.

Example 4. The computer-implemented method of any of the preceding examples, wherein the multidimensional anomaly detection filter comprises a multidimensional 9-point Laplacian filter.

Example 5. The computer-implemented method of any of the preceding examples, wherein applying the mixed pixel mask to the multispectral image comprises: locally normalizing the edges and the subpixel anomalies within the multispectral image using the volatility map; applying an edge filter mask to remove a portion of the edges and an anomaly filter mask to remove a portion of the subpixel anomalies to generate a map of pure pixels; applying a hierarchical clustering algorithm to the map of pure pixels to identify the clusters of pure materials; and applying a spectral unmixing procedure to generate a map of materials in the multispectral image.

Example 6. The computer-implemented method of any of the preceding examples, further comprising comparing to the map of materials to a past map of materials to determine material change pattern.

Example 7. The computer-implemented method of any of the preceding examples, wherein identifying the action plan comprises: determining a risk associated with the material change pattern; and generating an alert indicative of the risk associated with the material change pattern.

Example 8. The computer-implemented method of any of the preceding examples, wherein identifying the action plan comprises activating an equipment to clean or protect one or more points of interests identified to be affected by the material change pattern.

Example 9. A computer-implemented system comprising: memory storing application programming interface (API) information; and a server performing operations comprising: receiving a multispectral image corresponding to a region of interest, the multispectral image comprising aerial images of the region of interest captured by a multispectral sensor, the multispectral image comprises a plurality of pixels; processing the multispectral image, by applying a multidimensional edge detection filter to determine an edge index for the plurality of pixels and to determine edges within the multispectral image; processing the multispectral image, by applying a multidimensional anomaly detection filter to determine an anomaly index for the plurality of pixels and to determine subpixel anomalies within the multispectral image; determining, based on a local variability of spectra near each pixel within the multispectral image, a variability index within the multispectral image to generate a volatility map; applying a mixed pixel mask to filter out impure pixels from the multispectral image to generate a map comprising pure pixels; applying a density seeking hierarchical clustering algorithm, such as single-link clustering, to identify the clusters of pure materials in the multispectral image; applying a spectral unmixing procedure to generate a map of materials in the multispectral image; and identifying an action plan to remedy a risk associated with the map of materials.

Example 10. The computer-implemented system of the preceding example, wherein the mixed pixel mask is determined by: applying a local normalization by dividing the edge index by the variability index, to generate a normalized edge index for the plurality of pixels in the multispectral image; applying a local normalization by dividing the anomaly index by the variability index, to generate a normalized anomaly index for the plurality of pixels in the multispectral image; and determining the mixed pixel mask by unifying a first portion of the pixels having highest normalized edge index and a second portion of the pixels having the highest normalized anomaly index, representing the impure pixels.

Example 11. The computer-implemented system of any of the preceding examples, wherein the multidimensional edge detection filter comprises a Scharr filter.

Example 12. The computer-implemented system of any of the preceding examples, wherein the multidimensional anomaly detection filter comprises a multidimensional 9-point Laplacian filter.

Example 13. The computer-implemented system of any of the preceding examples, wherein applying the mixed pixel mask to the multispectral image comprises: locally normalizing the edges and the subpixel anomalies within the multispectral image using the volatility map; applying an edge filter mask to remove a portion of the edges and an anomaly filter mask to remove a portion of the subpixel anomalies to generate a map of pure pixels; applying a hierarchical clustering algorithm to the map of pure pixels to identify the clusters of pure materials; and applying a spectral unmixing procedure to generate a map of materials in the multispectral image.

Example 14. The computer-implemented system of any of the preceding examples, wherein the operations further comprise comparing to the map of materials to a past map of materials to determine material change pattern.

Example 15. The computer-implemented system of any of the preceding examples, wherein identifying the action plan comprises: determining a risk associated with the material change pattern; and generating an alert indicative of the risk associated with the material change pattern.

Example 16. The computer-implemented system of any of the preceding examples 5 wherein identifying the action plan comprises activating an equipment to clean or protect one or more points of interests identified to be affected by the material change pattern.

Example 17. A non-transitory computer-readable media encoded with a computer program, the computer program comprising instructions that when executed by one or more computers cause the one or more computers to perform operations comprising: receiving a multispectral image corresponding to a region of interest, the multispectral image comprising aerial images of the region of interest captured by a multispectral sensor, the multispectral image comprises a plurality of pixels; processing the multispectral image, by applying a multidimensional edge detection filter to determine an edge index for the plurality of pixels and to determine edges within the multispectral image; processing the multispectral image, by applying a multidimensional anomaly detection filter to determine an anomaly index for the plurality of pixels and to determine subpixel anomalies within the multispectral image; determining, based on a local variability of spectra near each pixel within the multispectral image, a variability index within the multispectral image to generate a volatility map; applying a mixed pixel mask to filter out impure pixels from the multispectral image to generate a map comprising pure pixels; applying a density seeking hierarchical clustering algorithm, such as single-link clustering, to identify the clusters of pure materials in the multispectral image; applying a spectral unmixing procedure to generate a map of materials in the multispectral image; and identifying an action plan to remedy a risk associated with the map of materials.

Example 18. The non-transitory computer-readable media of the preceding example, wherein the mixed pixel mask is determined by: applying a local normalization by dividing the edge index by the variability index, to generate a normalized edge index for the plurality of pixels in the multispectral image; applying a local normalization by dividing the anomaly index by the variability index, to generate a normalized anomaly index for the plurality of pixels in the multispectral image; and determining the mixed pixel mask by unifying a first portion of the pixels having highest normalized edge index and a second portion of the pixels having the highest normalized anomaly index, representing the impure pixels.

Example 19. The non-transitory computer-readable media of any of the preceding examples, wherein applying the mixed pixel mask to the multispectral image comprises: locally normalizing the edges and the subpixel anomalies within the multispectral image using the volatility map; applying an edge filter mask to remove a portion of the edges and an anomaly filter mask to remove a portion of the subpixel anomalies to generate a map of pure pixels; applying a hierarchical clustering algorithm to the map of pure pixels to identify the clusters of pure materials; and applying a spectral unmixing procedure to generate a map of materials in the multispectral image.

Example 20. The non-transitory computer-readable media of any of the preceding examples, wherein the operations further comprise comparing to the map of materials to a past map of materials to determine material change pattern and wherein identifying the action plan comprises: determining a risk associated with the material change pattern; and generating an alert indicative of the risk associated with the material change pattern.

What is claimed is:

1. A computer-implemented method comprising:
receiving a multispectral image corresponding to a region of interest, the multispectral image comprising aerial images of the region of interest captured by a multispectral sensor, the multispectral image comprises a plurality of pixels;
processing the multispectral image, by applying a multidimensional edge detection filter to determine an edge index for the plurality of pixels and to determine edges within the multispectral image;
processing the multispectral image, by applying a multidimensional anomaly detection filter to determine an anomaly index for the plurality of pixels and to determine subpixel anomalies within the multispectral image;
determining, based on a local variability of spectra near each pixel within the multispectral image, a variability index within the multispectral image to generate a volatility map;
applying a mixed pixel mask to filter out impure pixels from the multispectral image to generate a map comprising pure pixels;
applying a density seeking hierarchical clustering algorithm, such as single-link clustering, to identify the clusters of pure materials in the multispectral image;
applying a spectral unmixing procedure to generate a map of materials in the multispectral image; and
identifying an action plan to remedy a risk associated with the map of materials.

2. The computer-implemented method of claim 1, wherein the mixed pixel mask is determined by:
applying a local normalization by dividing the edge index by the variability index, to generate a normalized edge index for the plurality of pixels in the multispectral image;
applying a local normalization by dividing the anomaly index by the variability index, to generate a normalized anomaly index for the plurality of pixels in the multispectral image; and
determining the mixed pixel mask by unifying a first portion of the pixels having highest normalized edge index and a second portion of the pixels having the highest normalized anomaly index, representing the impure pixels.

3. The computer-implemented method of claim 1, wherein the multidimensional edge detection filter comprises a Scharr filter.

4. The computer-implemented method of claim 1, wherein the multidimensional anomaly detection filter comprises a multidimensional 9-point Laplacian filter.

5. The computer-implemented method of claim 1, wherein applying the mixed pixel mask to the multispectral image comprises:
locally normalizing the edges and the subpixel anomalies within the multispectral image using the volatility map;
applying an edge filter mask to remove a portion of the edges and an anomaly filter mask to remove a portion of the subpixel anomalies to generate a map of pure pixels;
applying a hierarchical clustering algorithm to the map of pure pixels to identify the clusters of pure materials; and
applying a spectral unmixing procedure to generate a map of materials in the multispectral image.

6. The computer-implemented method of claim 1, further comprising comparing to the map of materials to a past map of materials to determine material change pattern.

7. The computer-implemented method of claim 6, wherein identifying the action plan comprises:
determining a risk associated with the material change pattern; and
generating an alert indicative of the risk associated with the material change pattern.

8. The computer-implemented method of claim 7, wherein identifying the action plan comprises activating an equipment to clean or protect one or more points of interests identified to be affected by the material change pattern.

9. A computer-implemented system comprising:
memory storing application programming interface (API) information; and
a server performing operations comprising:
receiving a multispectral image corresponding to a region of interest, the multispectral image comprising aerial images of the region of interest captured by a multispectral sensor, the multispectral image comprises a plurality of pixels;
processing the multispectral image, by applying a multidimensional edge detection filter to determine an edge index for the plurality of pixels and to determine edges within the multispectral image;
processing the multispectral image, by applying a multidimensional anomaly detection filter to determine an anomaly index for the plurality of pixels and to determine subpixel anomalies within the multispectral image;
determining, based on a local variability of spectra near each pixel within the multispectral image, a variability index within the multispectral image to generate a volatility map;
applying a mixed pixel mask to filter out impure pixels from the multispectral image to generate a map comprising pure pixels;
applying a density seeking hierarchical clustering algorithm, such as single-link clustering, to identify the clusters of pure materials in the multispectral image;
applying a spectral unmixing procedure to generate a map of materials in the multispectral image; and
identifying an action plan to remedy a risk associated with the map of materials.

10. The computer-implemented system of claim 9, wherein the mixed pixel mask is determined by:
applying a local normalization by dividing the edge index by the variability index, to generate a normalized edge index for the plurality of pixels in the multispectral image;
applying a local normalization by dividing the anomaly index by the variability index, to generate a normalized anomaly index for the plurality of pixels in the multispectral image; and
determining the mixed pixel mask by unifying a first portion of the pixels having highest normalized edge index and a second portion of the pixels having the highest normalized anomaly index, representing the impure pixels.

11. The computer-implemented system of claim 9, wherein the multidimensional edge detection filter comprises a Scharr filter.

12. The computer-implemented system of claim 9, wherein the multidimensional anomaly detection filter comprises a multidimensional 9-point Laplacian filter.

13. The computer-implemented system of claim 9, wherein applying the mixed pixel mask to the multispectral image comprises:
locally normalizing the edges and the subpixel anomalies within the multispectral image using the volatility map;
applying an edge filter mask to remove a portion of the edges and an anomaly filter mask to remove a portion of the subpixel anomalies to generate a map of pure pixels;
applying a hierarchical clustering algorithm to the map of pure pixels to identify the clusters of pure materials; and
applying a spectral unmixing procedure to generate a map of materials in the multispectral image.

14. The computer-implemented system of claim 9, wherein the operations further comprise comparing to the map of materials to a past map of materials to determine material change pattern.

15. The computer-implemented system of claim 14, wherein identifying the action plan comprises:
determining a risk associated with the material change pattern; and
generating an alert indicative of the risk associated with the material change pattern.

16. The computer-implemented system of claim 15, wherein identifying the action plan comprises activating an equipment to clean or protect one or more points of interests identified to be affected by the material change pattern.

17. A non-transitory computer-readable media encoded with a computer program, the computer program comprising instructions that when executed by one or more computers cause the one or more computers to perform operations comprising:
receiving a multispectral image corresponding to a region of interest, the multispectral image comprising aerial images of the region of interest captured by a multispectral sensor, the multispectral image comprises a plurality of pixels;
processing the multispectral image, by applying a multidimensional edge detection filter to determine an edge index for the plurality of pixels and to determine edges within the multispectral image;
processing the multispectral image, by applying a multidimensional anomaly detection filter to determine an anomaly index for the plurality of pixels and to determine subpixel anomalies within the multispectral image;
determining, based on a local variability of spectra near each pixel within the multispectral image, a variability index within the multispectral image to generate a volatility map;
applying a mixed pixel mask to filter out impure pixels from the multispectral image to generate a map comprising pure pixels;
applying a density seeking hierarchical clustering algorithm, such as single-link clustering, to identify the clusters of pure materials in the multispectral image;
applying a spectral unmixing procedure to generate a map of materials in the multispectral image; and
identifying an action plan to remedy a risk associated with the map of materials.

18. The non-transitory computer-readable media of claim 17, wherein the mixed pixel mask is determined by:
applying a local normalization by dividing the edge index by the variability index, to generate a normalized edge index for the plurality of pixels in the multispectral image;
applying a local normalization by dividing the anomaly index by the variability index, to generate a normalized anomaly index for the plurality of pixels in the multispectral image; and
determining the mixed pixel mask by unifying a first portion of the pixels having highest normalized edge index and a second portion of the pixels having the highest normalized anomaly index, representing the impure pixels.

19. The non-transitory computer-readable media of claim 17, wherein applying the mixed pixel mask to the multispectral image comprises:
locally normalizing the edges and the subpixel anomalies within the multispectral image using the volatility map;
applying an edge filter mask to remove a portion of the edges and an anomaly filter mask to remove a portion of the subpixel anomalies to generate a map of pure pixels;
applying a hierarchical clustering algorithm to the map of pure pixels to identify the clusters of pure materials; and
applying a spectral unmixing procedure to generate a map of materials in the multispectral image.

20. The non-transitory computer-readable media of claim 17, wherein the operations further comprise comparing to the map of materials to a past map of materials to determine material change pattern and wherein identifying the action plan comprises:
determining a risk associated with the material change pattern; and
generating an alert indicative of the risk associated with the material change pattern.
